(19) United States
(12) Patent Application Publication
(10) Pub. No.: US 2024/0323737 A1
(43) Pub. Date: Sep. 26, 2024

(54) SYSTEMS AND METHODS OF WLAN SENSING PROCEDURE SETUP

(71) Applicant: Meta Platforms Technologies, LLC, Menlo Park, CA (US)

(72) Inventors: Claudio Rafael Cunha Monteiro da Silva, Kirkland, WA (US); Chunyu Hu, Saratoga, CA (US)

(73) Assignee: Meta Platforms Technologies, LLC, Menlo Park, CA (US)

(21) Appl. No.: 18/614,292

(22) Filed: Mar. 22, 2024

Related U.S. Application Data
(60) Provisional application No. 63/454,115, filed on Mar. 23, 2023.

(51) Int. Cl. H04W 24/10; H04W 28/20; H04W 84/12

(52) U.S. Cl. CPC H04W 24/10; H04W 28/20; H04W 84/12

(57) ABSTRACT

A first device may include one or more processors configured to define, specify, and/or signal new parameters relating to an earliest comeback time, a requested bandwidth, a minimum bandwidth, and/or an interval between sensing measurements The one or more processors may be configured to receive, through a transceiver from a second device in a wireless local area network (WLAN), a request frame indicating a request for a sensing measurement setup. Responsive to the request frame, the one or more processors may be configured to generate a response frame indicating that the request is rejected, the response frame including a first field indicating a minimum time for which the second device waits until sending a next request frame for a sensing measurement setup. The one or more processors may be configured to wirelessly transmit, through the transceiver to the second device in the WLAN, the response frame.

### CROSS-REFERENCE TO RELATED APPLICATION

This application claims priority to U.S. Provisional Patent Application No. 63/454,115 filed on Mar. 23, 2023, which is incorporated by reference herein in its entirety for all purposes.

### FIELD OF DISCLOSURE

The present disclosure is generally related to setting up a wireless local area network (WLAN) sensing procedure, including but not limited to systems and methods for defining/specifying/signaling new parameters relating to an earliest comeback time, a requested bandwidth, a minimum bandwidth, and/or an interval between sensing measurements.

### BACKGROUND

Artificial reality such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a first device including one or more processors. In some embodiments, the one or more processors may be configured to receive, through a transceiver from a second device in a wireless local area network (WLAN), a request frame indicating a request for a sensing measurement setup. Responsive to the request frame, the one or more processors may be configured to generate a response frame indicating that the request is rejected, the response frame including a first field indicating a minimum time for which the second device waits until sending a next request frame for a sensing measurement setup. The one or more processors may be configured to wirelessly transmit, through the transceiver to the second device in the WLAN, the response frame.

In some embodiments, the response frame may include a second field indicating a status code of responding to the request for the sensing measurement setup. In generating the response frame, the one or more processors may be configured to set the second field to a value indicating that the request is rejected, or a value indicating that the request is rejected with suggested changes.

In some embodiments, in generating the response frame, the one or more processors may be configured to set the first field to a binary value of n indicating the following time duration as the minimum time:

$${2}^{( n + k )} ms ,$$

where each of n and k is an integer greater than or equal to 0. The first field may have a size of 2 bits, and k is equal to 4.

In some embodiments, in generating the response frame, the one or more processors may be configured to set the first field to a value of 0 to indicate that there is no minimum time requirement for the second device to wait until sending the next request frame for the sensing measurement setup. In some embodiments, the response frame may include an information element (IE) for sensing measurement parameters, that includes the first field. The request frame may include the IE for sensing measurement parameters. The first field of the IE in the request frame may be a reserved field.

Various embodiments disclosed herein are related to a first device including one or more processors. In some embodiments, the one or more processors may be configured to generate a first frame indicating a request for a sensing measurement setup, the first frame including a first field indicating a minimum bandwidth to transmit signals for obtaining measurements. The one or more processors may be configured to wirelessly transmit, through a transmitter to a second device in a wireless local area network (WLAN), the first frame.

In some embodiments, the signals for obtaining the measurements may include at least one of a sensing initiator to sensing responder (SI2SR) null data packet (NDP), a sensing responder to sensing initiator (SR2SI) NDP, or a sensing responder to sensing responder (SR2SR) NDP. In some embodiments, the minimum bandwidth to transmit signals for obtaining measurements may be used during a trigger-based (TB) sensing measurement instance or during a non-TB sensing measurement instance.

In some embodiments, the first frame may include an information element (IE) sensing measurement parameters, that includes the first field. In some embodiments, the first frame may include a second field indicating a maximum bandwidth of the signals used to obtain the measurements. The IE may include the first field and the second field.

Various embodiments disclosed herein are related to a method including receiving, by a first device through a transceiver from a second device in a wireless local area network (WLAN), a request frame indicating a request for a sensing measurement setup. The method may include responsive to the request frame, generating, by the first device, a response frame indicating that the request is rejected, the response frame including a first field indicating a minimum time for which the second device waits until sending a next request frame for a sensing measurement setup. The method may include wirelessly transmitting, by the first device through the transceiver to the second device in the WLAN, the response frame.

In some embodiments, the response frame may include a second field indicating a status code of responding to the request for the sensing measurement setup. In generating the response frame, the first device may set the second field to a value indicating that the request is rejected, or a value indicating that the request is rejected with suggested changes.

In some embodiments, in generating the response frame, the first device may set the first field to a binary value of n indicating the following time duration as the minimum time:

$${2}^{( n + k )} ms ,$$

where each of n and k is an integer greater than or equal to 0. The first field may have a size of 2 bits, and k is equal to 4.

In some embodiments, in generating the response frame, the first device may set the first field to a value of 0 to indicate that there is no minimum time requirement for the second device to wait until sending the next request frame for the sensing measurement setup. In some embodiments, the response frame may include an information element (IE) for sensing measurement parameters, that includes the first field. The request frame may include the IE for sensing measurement parameters. The first field of the IE in the request frame may be a reserved field.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4A and FIG. 4B illustrate example wireless local area network (WLAN) sensing procedures between Wi-Fi devices, including a sensing measurement setup request and a sensing measurement setup response, according to an example implementation of the present disclosure.

FIG. 5 illustrate examples of field formats for signaling a parameter relating to an earliest comeback time, according to an example implementation of the present disclosure.

FIG. 6A to FIG. 6C illustrate examples of field formats for signaling a parameter relating to a requested bandwidth or a minimum bandwidth, according to an example implementation of the present disclosure.

FIG. 7 illustrate an example block diagram for defining/specifying a parameter relating to an interval between sensing measurements, according to an example implementation of the present disclosure.

FIG. 8 is a flowchart showing a process of defining/specifying/signaling a parameter relating to an earliest comeback time, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

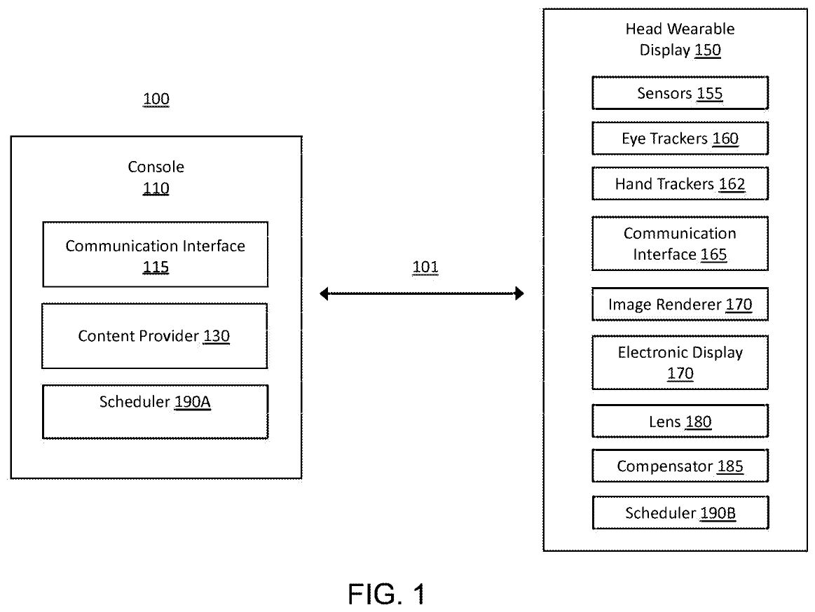

FIG. 1 is a block diagram of an example artificial reality system environment 100 in which a console 110 operates. FIG. 1 provides an example environment in which devices may communicate traffic streams with different latency sensitivities/requirements. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 110 through a wired or wireless connection. The HWD 150 may also identify objects (e.g., body, hand face).

The console 110 may determine a view within the space of the artificial reality corresponding to the detected location, orientation and/or the gaze direction, and generate an image depicting the determined view. The console 110 may also receive one or more user inputs and modify the image according to the user inputs. The console 110 may provide the image to the HWD 150 for rendering. The image of the space of the artificial reality corresponding to the user's view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150, and/or some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is-10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150, orientation of the HWD 150, the determined gaze direction of the user, and/or hand tracking measurements. Moreover, through the communication link, the communication interface 165 may receive from the console 110 sensor measurements indicating or corresponding to an image to be rendered.

Using the communication interface, the console 110 (or HWD 150) may coordinate operations on link 101 to reduce collisions or interferences. For example, the console 110 may coordinate communication between the console 110 and the HWD 150. In some implementations, the console 110 may transmit a beacon frame periodically to announce/advertise a presence of a wireless link between the console 110 and the HWD 150 (or between two HWDs). In an implementation, the HWD 150 may monitor for or receive the beacon frame from the console 110, and can schedule communication with the HWD 150 (e.g., using the information in the beacon frame, such as an offset value) to avoid collision or interference with communication between the console 110 and/or HWD 150 and other devices.

The console 110 and HWD 150 may communicate using link 101 (e.g., intralink). Data (e.g., a traffic stream) may flow in a direction on link 101. For example, the console 110 may communicate using a downlink (DL) communication to the HWD 150 and the HWD 150 may communicate using an uplink (UL) communication to the console 110.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced.

In some embodiments, the image renderer 170 receives, from the console, 110 additional data including object information indicating virtual objects in the artificial reality space and depth information indicating depth (or distances from the HWD 150) of the virtual objects. Accordingly, the image renderer 170 may receive from the console 110 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality.

In other implementations, the image renderer 170 generates one or more images through a shading process and a reprojection process when an image from the console 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150. In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable, a wireless link). Through the communication link, the communication interface 115 may receive from the HWD 150 sensor measurements indicating the determined location and/or orientation of the HWD 150, the determined gaze direction of the user, and/or hand tracking measurements. Moreover, through the communication link, the communication interface 115 may transmit to the HWD 150 data describing an image to be rendered.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

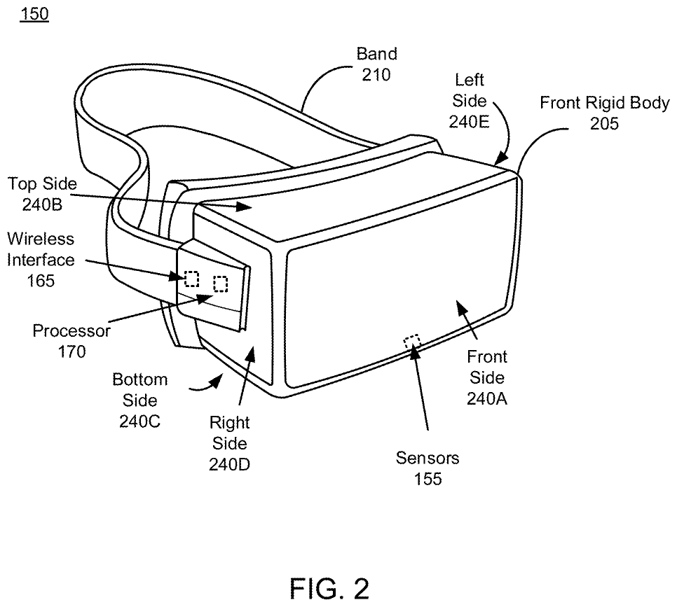

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

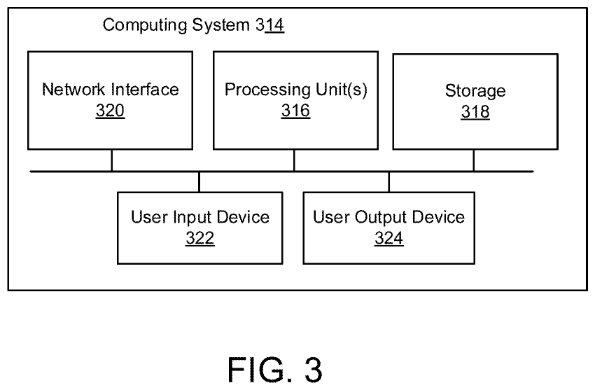

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

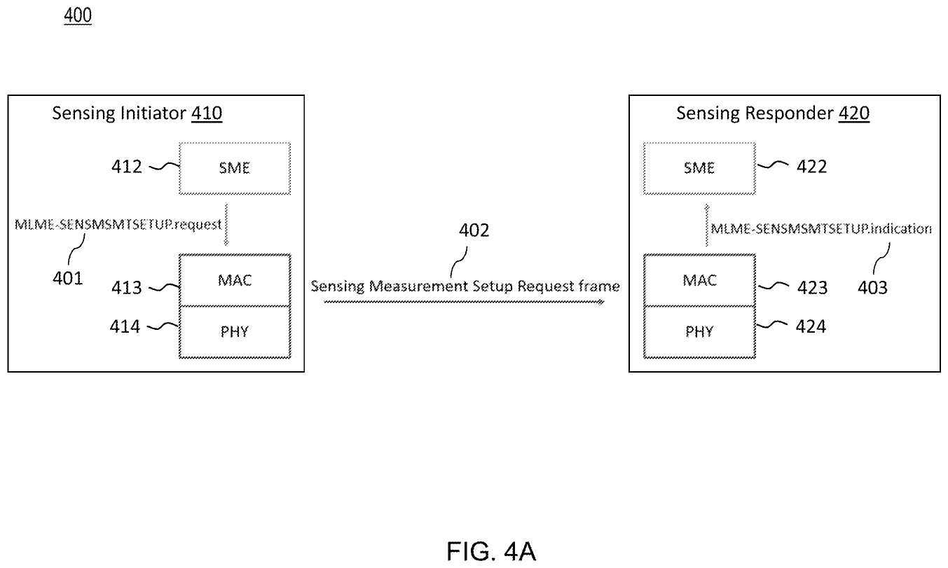

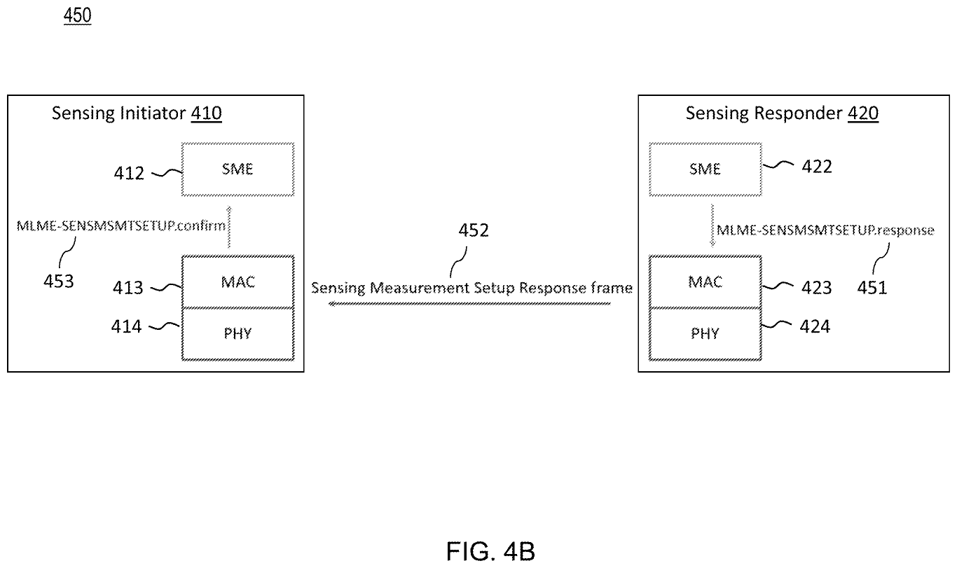

FIG. 4A and FIG. 4B illustrate example wireless local area network (WLAN) sensing procedures between Wi-Fi devices, including a sensing measurement setup request and a sensing measurement setup response, according to an example implementation of the present disclosure.

FIG. 4A shows a block diagram 400 in which a sensing initiator 410 sends a Sensing Measurement Setup Request frame 402 to a sensing responder 420. Each of the sensing initiator 410 and the sensing responder 420 may be a Wi-Fi/WLAN device. For example, the sensing initiator 410 may be a high-efficiency (HE) station (STA) or extremely high throughput (EHT) STA that can initiate a sensing procedure by transmitting a Sensing Measurement Request frame, or a directional multi-gigabit (DMG) STA that initiates a DMG sensing procedure by transmitting a DMG Sensing Measurement Request frame. The sensing responder 420 may be a HE STA or EHT STA that can participate in a sensing procedure by responding to a sensing initiator, or a DMG STA that participates in a DMG sensing procedure by responding to a sensing initiator.

Referring to FIG. 4A, to initiate a WLAN sensing procedure, a station management entity (SME) 412 of the sensing initiator 410 may generate an MLME (MAC Layer Management Entity)-SENSMSMTSETUP (Sensing Measurement Setup).request primitive 401 that triggers a media access control (MAC) layer 413 of the sensing initiator 410 to create and send, via a physical (PHY) layer 414, a Sensing Measurement Setup Request frame 402 to the sensing responder 420. The MLME-SENSMSMTSETUP.request primitive 401 may contain a MAC address of the sensing responder 420, token/ID values (e.g., Measurement Setup ID) that identify the request and the setup, and parameters of the requested WLAN sensing procedure, such as a bandwidth, a number of receive antennas, and/or a role of the sensing responder (transmitter, receiver, or both), among others. The Sensing Measurement Setup Request frame 402 may carry the same information contained in the MLME-SENSMSMTSETUP.request primitive. Upon reception and decoding of the Sensing Measurement Setup Request frame 402 (via a PHY layer 424 of the sensing responder 420), a MAC layer 423 of the sensing responder 420 may generate an MLME-SENSMSMTSETUP.indication primitive 403 and can send the primitive 403 to an SME 422 of the sensing responder 420. The MLME-SENSMSMTSETUP.indication 403 may contain the same information carried in the Sensing Measurement Setup Request frame 402 and the MLME-SENSMSMTSETUP.request primitive 401.

FIG. 4B shows a block diagram 450 in which the sensing responder 420 sends a Sensing Measurement Setup Response frame 452 to the sensing initiator 410. Referring to FIG. 4B, in response to the WLAN sensing request (as shown in FIG. 4A), the SME 422 of the sensing responder 420 may decide/determine whether to accept or reject the WLAN sensing request. Responsive to determining to reject the request, the SME 412 of the sensing responder 420 may send suggested sensing parameters that the sensing initiator 410 may consider in a future request. The SME 412 of the sensing responder 420 may generate an MLME-SENSMSMTSETUP.response primitive 451, which may include a decision of the sensing responder's SME (accept/reject) and possibly suggested sensing parameters (if the decision is to reject the request). Upon receiving the primitive 451, the MAC layer 423 of the sensing responder 420 may create and may send a Sensing Measurement Setup Response frame 452 to the sensing initiator 410. The Sensing Measurement Setup Response frame 452 may carry the same information contained in the MLME-SENSMSMTSETUP.response primitive 451. Upon reception and decoding of the Sensing Measurement Setup Response frame 452, the MAC layer 413 of the sensing initiator 410 may send an MLME-SENSMSMTSETUP.confirm primitive 453 to the SME 412 of the sensing initiator 410. The MLME-SENSMSMTSETUP.confirm primitive 453 may contain the same information carried in the Sensing Measurement Setup Response frame 452 and MLME-SENSMSMTSETUP.response primitive 451.

In one aspect, as shown in FIG. 4B, a sensing responder may reject a request for sensing (cither with or without suggested alternative sensing parameters). In some cases, if a Sensing Measurement Setup Response frame is received with a status code other than a status code indicating “success”, the measurement setup of a granted Measurement Setup ID may not be resumed and may be considered unsuccessful. In other words, if a sensing initiator receives a response that indicates a reject (or rejection), the setup process may be considered to be unsuccessful and may be terminated. Here, if the last request of a sensing initiator is rejected/declined, it is unclear whether the sensing initiator may or may not make another request to the same sensing responder. Moreover, if the sensing initiator (that has a request declined) makes successive requests to the same sensing responder in a short period of time, it would be inefficient due to poor use of the channel, and/or unnecessary load to the sensing responder, for example. It would be beneficial to clearly determine/define a next step that a sensing initiator can take if a setup request is rejected.

To address this problem, embodiments of the present disclosure provide mechanisms to define/specify/signal a parameter of “earliest comeback time” for cases when a first request for sensing measurement setup is declined, so that the sensing initiator may re-try to establish a sensing measurement setup and/or the sensing initiator may be allowed to send a second setup request. The parameter of earliest comeback time can define a timing of a successive request so that the sensing initiator can efficiently make successive requests to the same sensing responder.

In one approach, an SME of a sensing responder may define a parameter of earliest comeback time (or “minimum request interval”) in response to sensing requests that are not successful/accepted. In some embodiments, an SME of a sensing responder may define a parameter of earliest comeback time in response to determining that a sensing request previously made by a sending initiator is not successful/accepted. In some embodiments, the earliest comeback time may be a parameter of a MLME-SENSMSMTSETUP.response primitive and may be included in a Sensing Measurement Setup Response frame.

In some embodiments, the earliest comeback time (e.g., parameter of earliest comeback time) may indicate (or be defined/specified/signaled as) a minimum time that the sensing initiator may or should wait until sending another sensing request (e.g., another Sensing Measurement Setup Request frame) to the same sensing responder. In some embodiments, a value of the parameter of earliest comeback time may be determined for the case only when a status code of a Sensing Measurement Setup Response frame indicates that a request has been declined or rejected (e.g., REQUEST_DECLINED). In some embodiments, a value of the parameter of earliest comeback time may be determined for the case when a status code of a Sensing Measurement Setup Response frame indicates either that (1) a request has been declined or rejected (e.g., REQUEST_DECLINED) or that (2) a request has been declined or rejected with suggested changes (e.g., REJECTED_WITH_SUGGESTED_CHANGES). In some embodiments, two values of the parameter of earliest comeback time may be defined, one for the status code set to REQUEST_DECLINED and the other for the status code set to REJECTED_WITH_SUGGESTED_CHANGES.

In some embodiments, the sensing responder may define/specify/signal a time duration that the sensing initiator may or must wait before sending a new request, in an “earliest comeback time” parameter or field (or “ECT” parameter or field) in the Sensing Measurement Setup Response frame. For example, the ECT parameter or field set to a value of 16 (in the Sensing Measurement Setup Response frame) may indicate that the sensing initiator may or must wait for 16 ms before sending a new request.

In some embodiments, the sensing responder may define/specify/signal a time duration that the sensing initiator may or must wait before sending a new request by defining a number of bits (e.g., 2, 3, or 4) as an “earliest comeback time” parameter or field (or “ECT” parameter or field) in the Sensing Measurement Setup Response frame that would or can be converted into a time duration value by the following equation:

$${2}^{( ECT + k )} ms \qquad Equation ( 1 )$$

where a value of “ECT” is a binary value which is a non-negative integer, and k is a non-negative integer.

For example, if 2 bits are used in the representation of the ECT parameter or field and k is equal to 4, the possible values indicated by the ECT field would be 16 ms (ECT=“00”), 32 ms (ECT=“01”), 64 ms (ECT=“10”), or 128 ms (ECT=“11”). In some embodiments, the exact number of bits may be defined/signaled. The factor of 4 (k=4) is an example, and other values (e.g., k=8 or 12) can be used.

In some embodiments, the “earliest comeback time” parameter or field in a Sensing Measurement Setup Response frame may be set to 0, which may indicate that there is no time requirement for a sensing initiator to wait before sending a new request (e.g., Sensing Measurement Setup Request frame) to the same sensing responder.

In one approach, a Sensing Measurement Setup Response frame may include the fields of Category, Public Action/Protected Dual of Public Action, Dialog Token, Measurement Setup ID, Status Code, and/or Sensing Measurement Parameters Element. In some embodiments, the Sensing Measurement Setup Response frame may be protected, for example, sent after key establishment that can be protected using existing protection key hierarchy. In some embodiments, the field of Sensing Measurement Parameters Element may include the subfields of Element ID, Length, Element ID Extension, Sensing Measurement Parameters, and/or Sensing subelements. In some embodiments, the subfield of Sensing Measurement Parameters may include the subfields of Sensing Transmitter, Sensing Receiver, Sensing Measurement Report Requested, Measurement Setup Expiry Exponent, BW (bandwidth), Max TX HE-LTF (Long Training Field) Repetition, Max RX HE-LTF Repetition, Max TX STS (Space Time Streams), Max Rx STS, Number of RX Antennas, Report Timestamp, N_{b} (number of bits of channel state information (CSI)), I_{Ng} (subcarrier grouping setting), BSS (Basic Service Set) Color Information, and/or Earliest Comeback Time.

In some embodiments, the Earliest Comeback Time subfield may be defined/specified/signaled within a Sensing Measurement Setup Response frame when a status code carried in the Status Code field is either REQUEST_DECLINED or REJECTED_WITH_SUGGESTED_CHANGES. In some embodiments, the Earliest Comeback Time subfield may be defined/specified/signaled within a Sensing Measurement Parameters field, which is carried within a Sensing Measurement Parameters element.

In some embodiments, if the Earliest Comeback Time subfield is defined with 4 or less bits (e.g., using Equation (1) with k=4), some or all the 4 bits currently marked as “reserved” in the Sensing Measurement Parameters field may be reassigned/repurposed/redefined/re-allocated to the Earliest Comeback Time subfield. In some embodiments, the Earliest Comeback Time subfield may have more than 4 bits (e.g., with N bits (N>4)), and the Sensing Measurement Parameters element may be increased, for example, by 1 octet. With this change, the Earliest Comeback Time subfield may use 12 available bits (4 bits currently marked as “reserved” plus 8 new bits) which may be divided into two groups: (1) Earliest Comeback Time subfield (with N bits); and (2) reserved bits (12-N bits).

In some embodiments, the Sensing Measurement Parameters field may be carried in a Sensing Measurement Setup Response frame, a Sensing Measurement Setup Request frame, and/or a Sensing Measurement Setup Termination frame. In the Sensing Measurement Setup Request frame, the Earliest Comeback Time subfield may be reserved (e.g., not used). In the Sensing Measurement Setup Termination frame, the Earliest Comeback Time subfield may be defined either (1) to be reserved or (2) to have the same definition as the Sensing Measurement Setup Response frame (e.g., a time duration that a sensing initiator may or must wait before sending a new request).

In one aspect, the parameters that may be signaled within the MLME-SENSMSMTSETUP.request primitive and/or the Sensing Measurement Setup Request frame may include the bandwidth of signals used to obtain measurements (e.g., BW subfield of the Sensing Measurement Parameters subfield of the Sensing Measurement Parameters element). The signals used to obtain measurements may include a SI2SR (sensing initiator to sensing responder) NDP (null data packet which does not carry payload), a SR2SI (sensing responder to sensing initiator) NDP, and/or a SR2SR (sensing responder to sensing responder) NDP. Because a WLAN (e.g., 802.11 technology) may operate over unlicensed/license-exempt spectrum, it cannot be guaranteed that a certain bandwidth (BW) will or can be used in future transmissions. In some implementations, the BW subfield of the Sensing Measurement Parameters element (that is carried within the MLME-SENSMSMTSETUP.request primitive and/or the Sensing Measurement Setup Request frame) may be defined such that the BW subfield indicates a maximum bandwidth used to transmit a SI2SR NDP, a SR2SI NDP, or a SR2SR NDP as part of a trigger-based (TB) or non-TB sensing measurement instance. This implementation can only define a maximum value which may be used such that the BW of signals sent for measurements may be reduced and be different from the one negotiated during the sensing measurement setup. However, with the maximum bandwidth value only, it would be difficult to specify bandwidth requirements/limitations (e.g., bandwidth limitations requested by a sensing initiator).

To address these problems, embodiments of the present disclosure provide mechanisms to define/specify/signal a new parameter (e.g., to be specified by a sensing initiator's SME and/or signaled in a Sensing Measurement Setup Request frame) that allows a sensing application to determine/specify/signal (1) a requested bandwidth (e.g., requested by a sensing initiator) or (2) a minimum bandwidth for sensing measurements to be obtained with. A requested bandwidth value or a minimum bandwidth value for measurements would be more useful to specify BW requirements/limitations than a maximum bandwidth value.

In some embodiments, a parameter for a requested bandwidth or a minimum bandwidth may be defined/specified/signaled by either (1) modifying the definition of the existing BW subfield (e.g., a BW subfield that is carried within an MLME-SENSMSMTSETUP.request primitive and/or a Sensing Measurement Setup Request frame) or (2) defining a new BW subfield (referred to as “BW Requested” or “BW Minimum”, for example) that allows a sensing initiator to indicate a requested value or a minimum bandwidth value for measurements. In some embodiments, the existing BW subfield or the newly defined subfield of BW requested or BW minimum may be defined as (1) indicating a requested bandwidth used to transmit a SI2SR NDP, a SR2SI NDP, or a SR2SR NDP as part of a TB or non-TB sensing measurement instance; or (2) indicating a minimum bandwidth used to transmit a SI2SR NDP, a SR2SI NDP, or a SR2SR NDP as part of a TB or non-TB sensing measurement instance.

In one approach, a Sensing Measurement Setup Request frame may include the fields of Category, Public Action/Protected Dual of Public Action, Dialog Token, Sensing Comeback Info, Measurement Setup ID, and/or Sensing Measurement Parameters Element. In some embodiments, the Sensing Measurement Setup Request frame may be protected, for example, sent after key establishment that can be protected using existing protection key hierarchy. In some embodiments, the field of Sensing Measurement Parameters Element may include the subfields of Element ID, Length, Element ID Extension, Sensing Measurement Parameters, and/or Sensing subelements. In some embodiments, the subfield of Sensing Measurement Parameters may include the subfields of Sensing Transmitter, Sensing Receiver, Sensing Measurement Report Requested, Measurement Setup Expiry Exponent, BW, Max TX HE-LTF Repetition, Max RX HE-LTF Repetition, Max TX STS, Max Rx STS, Number of RX Antennas, Report Timestamp, N_{b}, I_{Ng}, BSS Color Information, and/or Reserved. In some embodiments, the existing BW subfield, the definition of which is modified/redefined/repurposed as the subfield of Requested Bandwidth or Minimum Bandwidth, may be carried within the Sensing Measurement Parameters field, which in turn may be carried within the Sensing Measurement Parameters element. In other words, the modified/redefined/repurposed subfield of BW Requested or BW Minimum can replace the existing BW subfield.

In some embodiments, the subfield of Sensing Measurement Parameters may include the subfields of Sensing Transmitter, Sensing Receiver, Sensing Measurement Report Requested, Measurement Setup Expiry Exponent, BW, Max TX HE-LTF Repetition, Max RX HE-LTF Repetition, Max TX STS, Max Rx STS, Number of RX Antennas, Report Timestamp, N_{b}, I_{Ng}, BSS Color Information, and/or BW Requested/BW Minimum. In some embodiments, the (new) subfield of BW Requested/BW Minimum can be defined in addition to the existing BW subfield. In some embodiments, the new subfield of BW Requested/BW Minimum can make use of reserved bits (e.g., reserved bits of Sensing Measurement Parameters).

In one aspect, once a request for WLAN sensing measurements is accepted, the two STAs (e.g., sensing initiator and sensing responder) may perform frame exchanges with a certain time regularity that allows for one or both STAs to measure the channel. In some implementations, a sensing application that the sensing initiator supports may determine/request a time interval in which channel measurements are obtained. For example, an application that tracks the movement of elderly people to detect possible falls/injuries (e.g., fast movements) may require measurements to be taken more often than an application that intends to detect whether there is movement in a target room (e.g., slow movements). In some implementations, the SME of the sensing initiator may generate an MLME-SENSTBMSMTRQ.request primitive (for a TB sensing measurement instance) and/or an MLME-SENSNTBMSMTRQ.request primitive (for a non-TB sensing measurement instance) to determine/request a time interval in which channel measurements are obtained each time that a measurement is to be taken. This process may not be efficient as this signaling may be performed for individual measurements.

To address these problems, embodiments of the present disclosure provide mechanisms to define/specify/signal a new parameter (e.g., to be specified by an SME of the sensing initiator) that allows a sensing application to define a time interval between sensing measurements. Because for most applications of interest, a time interval in which measurements are to be taken is regular, the MAC can more efficiently schedule transmissions using the time interval between sensing measurements. For example, using the parameter of a time interval between sensing measurements, the SME can make a request for multiple measurements (with a given periodicity) as opposed to individual measurements.

In some embodiments, a parameter that defines either a requested interval or a maximum interval in which measurements are obtained may or must be defined within an MLME-SENSTBMSMTRQ.request primitive and/or and MLME-SENSNTBMSMTRQ.request primitive. For example, a SME of a sensing initiator may generate an MLME-SENSTBMSMTRQ.request primitive that includes the parameter of requested interval or maximum interval (e.g., “Requested Measurement Interval” parameter) in which measurements are obtained, may trigger a MAC layer and a PHY layer of the sensing initiator to obtain measurements in the requested interval or the maximum interval.

In some embodiments, the sensing initiator may define/specify/signal a requested interval or a maximum interval in which measurements are obtained, in the Requested Measurement Interval parameter in the MLME-SENSTBMSMTRQ.request primitive and/or and MLME-SENSNTBMSMTRQ.request primitive. This new parameter “Requested Measurement Interval” may define either as (1) a requested interval or (2) a maximum interval, in which measurements are to be obtained, and can allow the SME of the sensing initiator to pass this value to the MAC layer of the SME. For example, the Requested Measurement Interval parameter set to a value of 16 may indicate that the sensing initiator is making a request for obtaining measurements at a maximum interval of 16 ms (e.g., obtaining measurements every 16 ms or more frequently).

In some embodiments, the sensing initiator may define/specify/signal/encode a requested interval or a maximum interval in which measurements are obtained by defining a number of bits (e.g., 2, 3, or 4) as the Requested Measurement Interval parameter (or “RMI” parameter) or that would or can be converted into a time duration value by the following equation:

$${2}^{( RMI + k )} ms \qquad Equation ( 2 )$$

where a value of “RMI” is a binary value which is a non-negative integer, and k is a non-negative integer.

For example, if 2 bits are used in the representation of the RMI parameter and k is equal to 4, the possible values indicated by the RMI parameter would be 16 ms (RMI=“00”), 32 ms (RMI=“01”), 64 ms (RMI=“10”), or 128 ms (RMI=“11”). In some embodiments, the exact number of bits may be defined/signaled. The factor of 4 (k=4) is an example, and other values (e.g., k=8 or 12) can be used.

Embodiments in the present disclosure have at least the following advantages and benefits. First, embodiments in the present disclosure can provide useful techniques for defining/specifying/signaling a parameter of “earliest comeback time” for cases when a first request for sensing measurement setup is declined, so that the sensing initiator may re-try to establish a sensing measurement setup and/or the sensing initiator may be allowed to send a second setup request. The parameter of earliest comeback time can define a timing of a successive request so that the sensing initiator can efficiently make successive requests to the same sensing responder. With this configuration, if the last request of a sensing initiator is rejected, it can be clearly defined whether the sensing initiator may or may not make another request to the same sensing responder. Moreover, a period of time that the sensing initiator (that has a request declined) waits until making a next request to the same sensing responder can be defined such that the next request can be performed without putting unnecessary load to the sensing responder.

Second, embodiments in the present disclosure can provide useful techniques for defining/specifying/signaling a new parameter that allows a sensing application to determine/specify/signal (1) a requested bandwidth (e.g., requested by a sensing initiator) or (2) a minimum bandwidth for sensing measurements to be obtained with. A requested bandwidth value or a minimum bandwidth value for measurements would be more useful to specify BW requirements/limitations than a maximum bandwidth value. With this configuration, the sensing initiator can specify bandwidth requirements/limitations (e.g., bandwidth limitations requested by a sensing initiator).

Third, embodiments in the present disclosure can provide useful techniques for defining/specifying/signaling a new parameter that allows a sensing application to define a time interval between sensing measurements. Because for most applications of interest, a time interval in which measurements are to be taken is regular, the MAC can more efficiently schedule transmissions using the time interval between sensing measurements. For example, using the parameter of a time interval between sensing measurements, the SME can make a request for multiple measurements (with a given periodicity) as opposed to individual measurements.

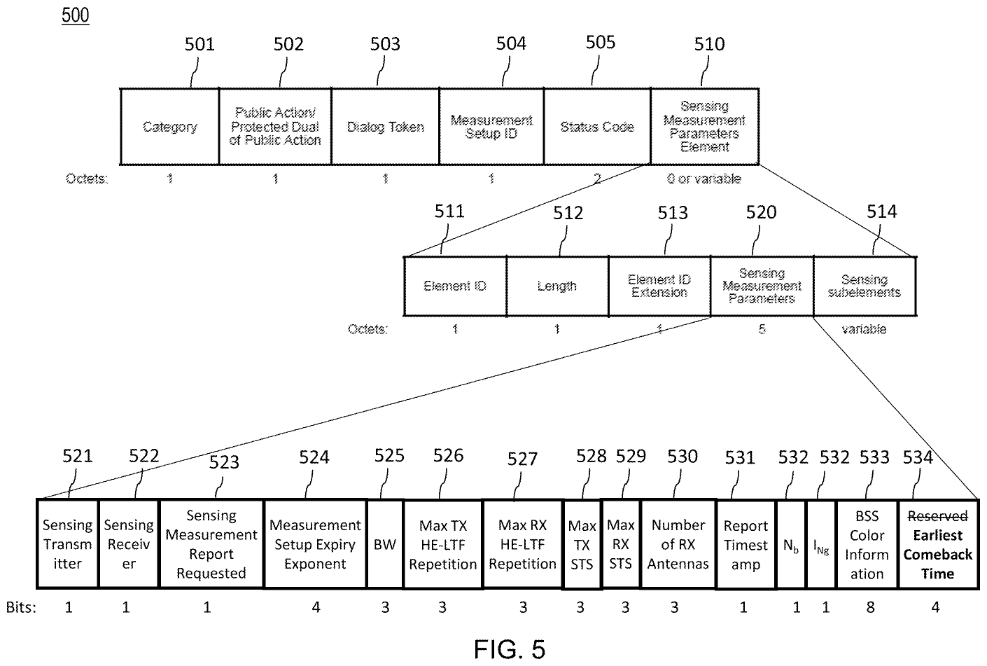

FIG. 5 illustrate examples of field formats for signaling a parameter relating to an earliest comeback time, according to an example implementation of the present disclosure. Referring to FIG. 5, a Sensing Measurement Setup Response frame 500 may include the fields of Category 501, Public Action/Protected Dual of Public Action 502, Dialog Token 503, Measurement Setup ID 504, Status Code 505, and/or Sensing Measurement Parameters Element 510. The Sensing Measurement Setup Response frame 500 may be protected. The field of Sensing Measurement Parameters Element 510 may include the subfields of Element ID 511, Length 512, Element ID Extension 513, Sensing Measurement Parameters 520, and/or Sensing subelements 514. The subfield of Sensing Measurement Parameters 520 may include the subfields of Sensing Transmitter 521, Sensing Receiver 522, Sensing Measurement Report Requested 523, Measurement Setup Expiry Exponent 524, BW (bandwidth) 525, Max TX HE-LTF Repetition 526, Max RX HE-LTF Repetition 527, Max TX STS 528, Max Rx STS 529, Number of RX Antennas 530, Report Timestamp 531, N_{b} 531, I_{Ng} 532, BSS Color Information 533, and/or Earliest Comeback Time 534.

The Earliest Comeback Time subfield 534 may indicate (or be defined/specified/signaled as) a minimum time that the sensing initiator may or should wait until sending another sensing request (e.g., another Sensing Measurement Setup Request frame) to the same sensing responder. A value of the Earliest Comeback Time subfield 534 may be determined for the case only when a status code of the Sensing Measurement Setup Response frame (e.g., Status Code field 505) indicates that a request has been declined or rejected (e.g., REQUEST_DECLINED). In some embodiments, a value of the Earliest Comeback Time subfield 534 may be determined for the case when a status code of a Sensing Measurement Setup Response frame (e.g., Status Code field 505) indicates either that (1) a request has been declined or rejected (e.g., REQUEST_DECLINED) or that (2) a request has been declined or rejected with suggested changes (e.g., REJECTED_WITH_SUGGESTED_CHANGES). In some embodiments, two values of the Earliest Comeback Time subfield 534 may be defined, one for the status code set to REQUEST_DECLINED and the other for the status code set to REJECTED_WITH_SUGGESTED_CHANGES.

The Earliest Comeback Time subfield 534 may be defined/specified/signaled within the Sensing Measurement Setup Response frame 500 when a status code carried in the Status Code field 505 is either REQUEST_DECLINED or REJECTED_WITH_SUGGESTED_CHANGES. The Earliest Comeback Time subfield 534 may be defined/specified/signaled within the Sensing Measurement Parameters field 520, which is carried within the Sensing Measurement Parameters element 510. In some embodiments, the Earliest Comeback Time subfield 534 may indicate a time duration that the sensing initiator may or must wait before sending a new request. For example, the Earliest Comeback Time subfield 534 set to a value of 16 may indicate that a sensing initiator (e.g., sensing initiator 410 in FIG. 4B) may or must wait for 16 ms before sending a new request.

In some embodiments, the Earliest Comeback Time subfield 534 may indicate a time duration that the sensing initiator may or must wait before sending a new request by defining a number of bits (e.g., 2, 3, or 4) that would or can be converted into a time duration value using Equation (1). For example, if 2 bits are used in the representation of the Earliest Comeback Time subfield 534 and k is equal to 4 in Equation (1), the possible values indicated by the Earliest Comeback Time subfield 534 would be 16 ms (ECT=“00”), 32 ms (ECT=“01”), 64 ms (ECT=“10”), or 128 ms (ECT=“11”). In some embodiments, the exact number of bits may be defined/signaled (e.g., using a reserved bit in the Sensing Measurement Parameters field 520 or the Sensing Measurement Parameters element 510). The factor of 4 (k=4) is an example, and other values (e.g., k=8 or 12) can be used. In some embodiments, the Earliest Comeback Time subfield 534 may be set to 0, which may indicate that there is no time requirement for a sensing initiator (e.g., sensing initiator 410) to wait before sending a new request (e.g., Sensing Measurement Setup Request frame) to the same sensing responder (e.g., sensing responder 420).

In some embodiments, if the Earliest Comeback Time subfield is defined with 4 or less bits (e.g., using Equation (1) with k=4), some or all the 4 bits currently marked as “reserved” 534 in the Sensing Measurement Parameters field 520 may be reassigned/repurposed/redefined/re-allocate to the Earliest Comeback Time subfield. In some embodiments, the Earliest Comeback Time subfield may have more than 4 bits (e.g., with N bits (N>4)), and the Sensing Measurement Parameters element 510 may be increased, for example, by 1 octet. With this change, the Earliest Comeback Time subfield may use 12 available bits (4 bits currently marked as “reserved” 534 plus 8 new bits) which may be divided into two groups: (1) Earliest Comeback Time subfield (with N bits); and (2) (new) reserved bits (12-N bits).

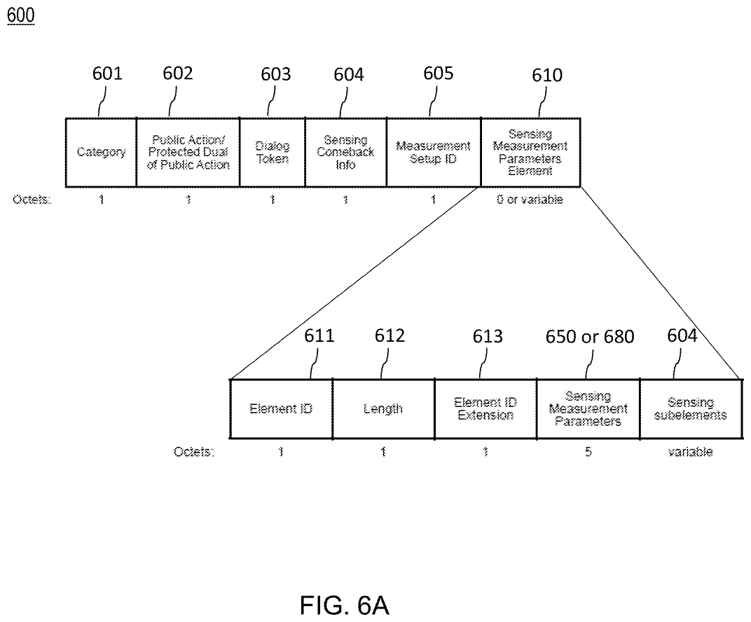

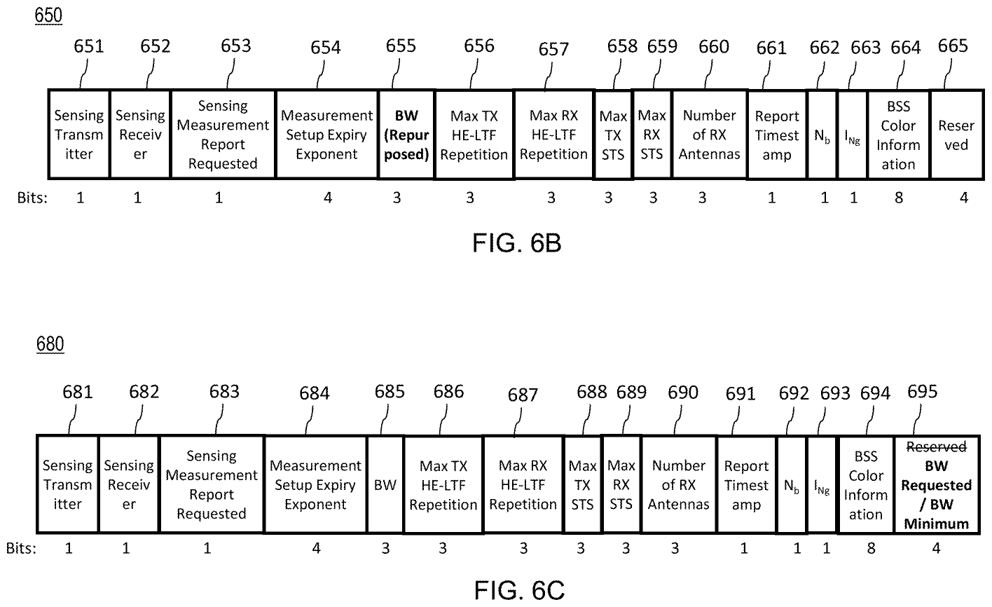

In some embodiments, the Sensing Measurement Parameters field 520 may be carried in a Sensing Measurement Setup Response frame (e.g., Sensing Measurement Setup Response frame 500), a Sensing Measurement Setup Request frame (e.g., Sensing Measurement Setup Request frame 600; see FIG. 6A), and/or a Sensing Measurement Setup Termination frame (not shown). In the Sensing Measurement Setup Request frame, the Earliest Comeback Time subfield may be reserved (e.g., not used). In the Sensing Measurement Setup Termination frame, the Earliest Comeback Time subfield may be defined either (1) to be reserved or (2) to have the same definition as the Sensing Measurement Setup Response frame (e.g., a time duration that a sensing initiator may or must wait before sending a new request).

Referring to FIGS. 4B and 5, an SME of a sensing responder (e.g., SME 422) may define/specify/signal the Earliest Comeback Time subfield 534 in response to sensing requests that are not successful/accepted. The SME of the sensing responder may define/specify/signal the Earliest Comeback Time subfield 534 in response to determining that a sensing request previously made by a sending initiator is not successful/accepted. The Earliest Comeback Time subfield may be a parameter of a MLME-SENSMSMTSETUP.response primitive (e.g., MLME-SENSMSMTSETUP.response 451) and may be included in a Sensing Measurement Setup Response frame (e.g., Sensing Measurement Setup Response frame 452).

FIG. 6A to FIG. 6C illustrate examples of field formats for signaling a parameter relating to a requested bandwidth or a minimum bandwidth, according to an example implementation of the present disclosure. FIG. 6A shows a Sensing Measurement Setup Request frame 600 including the fields of Category 601, Public Action/Protected Dual of Public Action 602, Dialog Token 603, Sensing Comeback Info 604, Measurement Setup ID 605, and/or Sensing Measurement Parameters Element 610. The Sensing Measurement Setup Request frame 600 may be protected. The field of Sensing Measurement Parameters Element 610 may include the subfields of Element ID 611, Length 612, Element ID Extension 613, Sensing Measurement Parameters (e.g., Sensing Measurement Parameters 650 in FIG. 6B or Sensing Measurement Parameters 680 in FIG. 6C), and/or Sensing subelements 604.

Referring to FIG. 6B, the subfield of Sensing Measurement Parameters 650 may include the subfields of Sensing Transmitter 651, Sensing Receiver 652, Sensing Measurement Report Requested 653, Measurement Setup Expiry Exponent 654, BW 655, Max TX HE-LTF Repetition 656, Max RX HE-LTF Repetition 657, Max TX STS 658, Max Rx STS 659, Number of RX Antennas 660, Report Timestamp 661, N_{b} 662, I_{Ng} 663, BSS Color Information 664, and/or Reserved 665. In some embodiments, the definition of the existing BW subfield 655 may be modified/redefined/repurposed as the subfield of Requested Bandwidth or Minimum Bandwidth. In other words, the modified/redefined/repurposed subfield of BW Requested or BW Minimum 655 can replace the existing BW subfield.

Referring to FIG. 6C, the subfield of Sensing Measurement Parameters 680 may include the subfields of Sensing Transmitter 681, Sensing Receiver 682, Sensing Measurement Report Requested 683, Measurement Setup Expiry Exponent 684, BW 685, Max TX HE-LTF Repetition 686, Max RX HE-LTF Repetition 687, Max TX STS 688, Max Rx STS 689, Number of RX Antennas 690, Report Timestamp 691, N_{b} 692, I_{Ng} 693, BSS Color Information 694, and/or BW Requested/BW Minimum 695. In some embodiments, the (new) subfield of BW Requested/BW Minimum 695 can be defined in addition to the existing BW subfield 685. The new subfield of BW Requested/BW Minimum 695 can make use of reserved bits (e.g., reserved bits of the Sensing Measurement Parameters subfield 680).

The repurposed BW subfield 655 or the new BW Requested/BW Minimum subfield 695 (which can be specified by a sensing initiator's SME and/or signaled in the Sensing Measurement Setup Request frame 600) may allow a sensing application to determine/specify/signal (1) a requested bandwidth (e.g., requested by a sensing initiator) or (2) a minimum bandwidth for sensing measurements to be obtained with. A requested bandwidth value or a minimum bandwidth value for measurements would be more useful to specify BW requirements/limitations than a maximum bandwidth value. The repurposed BW subfield 655 or the new BW Requested/BW Minimum subfield 695 may be defined as (1) indicating a requested bandwidth used to transmit a SI2SR NDP, a SR2SI NDP, or a SR2SR NDP as part of a TB or non-TB sensing measurement instance; or (2) indicating a minimum bandwidth used to transmit a SI2SR NDP, a SR2SI NDP, or a SR2SR NDP as part of a TB or non-TB sensing measurement instance.

In some embodiments, a first device (e.g., console 110, HWD 150, sensing initiator 410) may include one or more processors (e.g., processors 316). The one or more processors may generate a first frame (e.g., Sensing Measurement Setup Request frame 402, 600) indicating a request for a sensing measurement setup, the first frame including a first field (e.g., BW subfield 655, or BW Requested/BW Minimum subfield 695) indicating a minimum bandwidth to transmit signals for obtaining measurements. The one or more processors may wirelessly transmit, through a transmitter to a second device (e.g., console 110, HWD 150, sensing responder 420) in a wireless local area network (WLAN), the first frame (e.g., Sensing Measurement Setup Request frame 402, 600).

In some embodiments, the signals for obtaining the measurements may include at least one of a SI2SR NDP, a SR2SI NDP, or a SR2SR NDP. In some embodiments, the minimum bandwidth to transmit signals for obtaining measurements may be used during a TB sensing measurement instance or during a non-TB sensing measurement instance.

In some embodiments, the first frame (e.g., Sensing Measurement Setup Request frame 600) may include an information element (IE) sensing measurement parameters (e.g., Sensing Measurement Parameter Element 610), that includes the first field (e.g., repurposed BW subfield 655, or BW Requested/BW Minimum subfield 695). In some embodiments, the first frame may include a second field (e.g., existing BW subfield 685) indicating a maximum bandwidth of the signals used to obtain the measurements. The IE may include the first field (e.g., BW Requested/BW Minimum subfield 695) and the second field (e.g., existing BW subfield 685).

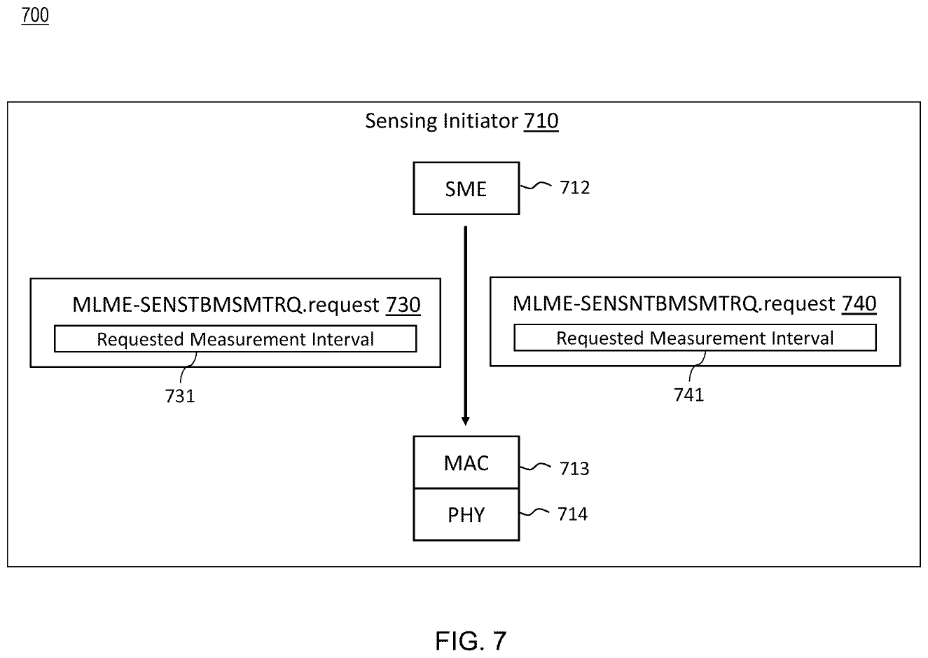

FIG. 7 illustrate an example block diagram 700 for defining/specifying a parameter relating to an interval between sensing measurements, according to an example implementation of the present disclosure. Referring to FIG. 7, a parameter that defines either a requested interval or a maximum interval in which measurements are obtained (e.g., parameter of Requested Measured Interval 731, 741) may or must be defined within an MLME-SENSTBMSMTRQ.request primitive (e.g., MLME-SENSTBMSMTRQ.request 730) and/or and MLME-SENSNTBMSMTRQ.request primitive (e.g., MLME-SENSNTBMSMTRQ.request 740). For example, a SME 712 of a sensing initiator 710 may generate an MLME-SENSTBMSMTRQ.request primitive 730 that includes the parameter of requested interval or maximum interval (e.g., “Requested Measurement Interval” parameter) in which measurements are obtained, may trigger a MAC layer 713 and a PHY layer 714 of the sensing initiator 710 to obtain measurements in the requested interval or the maximum interval.

Referring to FIG. 7, the sensing initiator 710 may define/specify/signal a requested interval or a maximum interval in which measurements are obtained, in the Requested Measurement Interval parameter 731, 741 in the MLME-SENSTBMSMTRQ.request primitive 730 and/or and MLME-SENSNTBMSMTRQ.request primitive 740. This new parameter “Requested Measurement Interval” 731, 741 may define either as (1) a requested interval or (2) a maximum interval, in which measurements are to be obtained, and can allow the SME 712 of the sensing initiator 710 to pass this value to the MAC layer 713 of the SME 712. For example, the Requested Measurement Interval parameter 731, 741 set to a value of 16 may indicate that the sensing initiator 710 is making a request for obtaining measurements at a maximum interval of 16 ms (e.g., obtaining measurements every 16 ms or more frequently).

In some embodiments, the sensing initiator 710 may define/specify/signal/encode a requested interval or a maximum interval in which measurements are obtained by defining a number of bits (e.g., 2, 3, or 4) as the Requested Measurement Interval parameter 731, 741 that would or can be converted into a time duration value by Equation (2).

For example, if 2 bits are used in the representation of the Requested Measurement Interval parameter 731 and k is equal to 4 in Equation (2), the possible values indicated by the Requested Measurement Interval parameter 731 (or “RMI”) would be 16 ms (RMI=“00”), 32 ms (RMI=“01”), 64 ms (RMI=“10”), or 128 ms (RMI=“11”). In some embodiments, the exact number of bits may be defined/signaled. The factor of 4 (k=4) is an example, and other values (e.g., k=8 or 12) can be used.

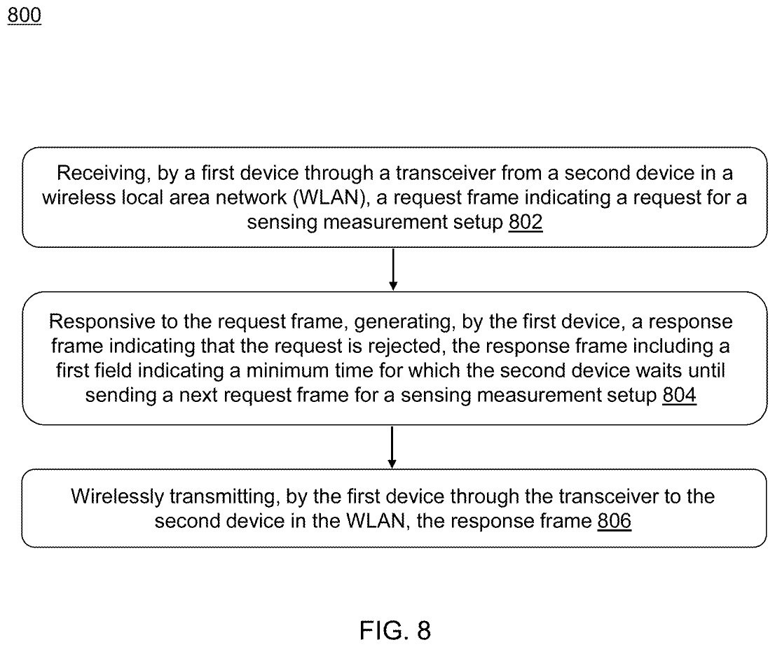

FIG. 8 is a flowchart showing a process 800 of defining/specifying/signaling a parameter relating to an earliest comeback time, according to an example implementation of the present disclosure. In some embodiments, the process 1200 is performed by a first device (e.g., console 110, HWD 150, computer system 314, sensing responder 420). In some embodiments, the process 800 is performed by other entities. In some embodiments, the process 800 includes more, fewer, or different steps than shown in FIG. 8.

In one approach, the first device may receive 802, through a transceiver from a second device (e.g., console 110, HWD 150, computer system 314, sensing initiator 410) in a WLAN, a request frame (e.g., Sensing Measurement Setup Request frame 402) indicating a request for a sensing measurement setup.

In one approach, responsive to the request frame (e.g., Sensing Measurement Setup Request frame 402), the first device (e.g., sensing responder 420) may generate 804 a response frame (e.g., Sensing Measurement Setup Response frame 452, 500) indicating that the request is rejected, the response frame including a first field (e.g., Earliest Comeback Time subfield 534) indicating a minimum time for which the second device (e.g., sensing initiator 410) waits until sending a next request frame for a sensing measurement setup.

In some embodiments, the response frame (e.g., Sensing Measurement Setup Response frame 500) may include a second field (e.g., Status Code field 505) indicating a status code of responding to the request for the sensing measurement setup. In generating the response frame, the first device (e.g., sensing responder 420) may set the second field (e.g., Status Code field 505) to a value indicating that the request is rejected (e.g., REQUEST_DECLINED), or a value indicating that the request is rejected with suggested changes (e.g., REJECTED_WITH_SUGGESTED_CHANGES).

In some embodiments, in generating the response frame (e.g., Sensing Measurement Setup Response frame 500), the first device (e.g., sensing responder 420) may set the first field (e.g., Earliest Comeback Time subfield 534) to a binary value of n indicating the following time duration as the minimum time:

$${2}^{( n + k )} ms ,$$

where each of n and k is an integer greater than or equal to 0. The first field may have a size of 2 bits, and k is equal to 4.

In some embodiments, in generating the response frame (e.g., Sensing Measurement Setup Response frame 500), the first device (e.g., sensing responder 420) may set the first field (e.g., Earliest Comeback Time subfield 534) to a value of 0 to indicate that there is no minimum time requirement for the second device (e.g., sensing initiator 410) to wait until sending the next request frame for the sensing measurement setup. In some embodiments, the response frame may include an information element (IE) for sensing measurement parameters (e.g., Sensing Measurement Parameters Element 510), that includes the first field (e.g., Earliest Comeback Time subfield 534). The request frame (e.g., Sensing Measurement Setup Request frame 600) may include the IE (e.g., Sensing Measurement Parameters Element 610) for sensing measurement parameters. The first field of the IE in the request frame may be a reserved field (e.g., Reserved subfield 665).

In one approach, the first device (e.g., sensing responder 420) may wirelessly transmit 806, through the transceiver to the second device in the WLAN, the response frame (e.g., Sensing Measurement Setup Response frame 452, 500).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first device comprising:
one or more processors configured to:
receive, through a transceiver from a second device in a wireless local area network (WLAN), a request frame indicating a request for a sensing measurement setup;
responsive to the request frame, generate a response frame indicating that the request is rejected, the response frame comprising a first field indicating a minimum time for which the second device waits until sending a next request frame for a sensing measurement setup; and
wirelessly transmit, through the transceiver to the second device in the WLAN, the response frame.

2. The first device according to claim 1, wherein
the response frame comprises a second field indicating a status code of responding to the request for the sensing measurement setup, and
in generating the response frame, the one or more processors are configured to set the second field to a value indicating that the request is rejected, or a value indicating that the request is rejected with suggested changes.

3. The first device according to claim 1, wherein in generating the response frame, the one or more processors are configured to set the first field to a binary value of n indicating the following time duration as the minimum time:
$${2}^{( n + k )} ms ,$$
where each of n and k is an integer greater than or equal to 0.

4. The first device according to claim 3, wherein the first field has a size of 2 bits, and k is equal to 4.

5. The first device according to claim 1, wherein in generating the response frame, the one or more processors are configured to set the first field to a value of 0 to indicate that there is no minimum time requirement for the second device to wait until sending the next request frame for the sensing measurement setup.

6. The first device according to claim 1, wherein
the response frame comprises an information element (IE) for sensing measurement parameters, that includes the first field.

7. The first device according to claim 6, wherein
the request frame comprises the IE for sensing measurement parameters, and
the first field of the IE in the request frame is a reserved field.

8. A first device comprising:
one or more processors configured to:
generate a first frame indicating a request for a sensing measurement setup, the first frame comprising a first field indicating a minimum bandwidth to transmit signals for obtaining measurements; and
wirelessly transmit, through a transmitter to a second device in a wireless local area network (WLAN), the first frame.

9. The first device according to claim 8, wherein the signals for obtaining the measurements comprise at least one of a sensing initiator to sensing responder (SI2SR) null data packet (NDP), a sensing responder to sensing initiator (SR2SI) NDP, or a sensing responder to sensing responder (SR2SR) NDP.

10. The first device according to claim 8, wherein the minimum bandwidth to transmit signals for obtaining measurements is used during a trigger-based (TB) sensing measurement instance or during a non-TB sensing measurement instance.

11. The first device according to claim 8, wherein the first frame comprises an information element (IE) sensing measurement parameters, that includes the first field.

12. The first device according to claim 8, wherein the first frame comprises a second field indicating a maximum bandwidth of the signals used to obtain the measurements.

13. The first device according to claim 11, wherein the IE includes the first field and the second field.

14. A method comprising:
receiving, by a first device through a transceiver from a second device in a wireless local area network (WLAN), a request frame indicating a request for a sensing measurement setup;
responsive to the request frame, generating, by the first device, a response frame indicating that the request is rejected, the response frame comprising a first field indicating a minimum time for which the second device waits until sending a next request frame for a sensing measurement setup; and
wirelessly transmitting, by the first device through the transceiver to the second device in the WLAN, the response frame.

15. The method according to claim 14, wherein
the response frame comprises a second field indicating a status code of responding to the request for the sensing measurement setup, and
generating the response frame comprises setting the second field to a value indicating that the request is rejected, or a value indicating that the request is rejected with suggested changes.

16. The method according to claim 14, wherein generating the response frame comprises setting the first field to a binary value of n indicating the following time duration as the minimum time:
$${2}^{( n + k )} ms ,$$
where each of n and k is an integer greater than or equal to 0.

17. The method according to claim 16, wherein the first field has a size of 2 bits, and k is equal to 4.

18. The method according to claim 14, wherein generating the response frame comprises setting the first field to a value of 0 to indicate that there is no minimum time requirement for the second device to wait until sending the next request frame for the sensing measurement setup.

19. The method according to claim 14, wherein
the response frame comprises an information element (IE) for sensing measurement parameters, that includes the first field.

20. The method according to claim 19, wherein
the request frame comprises the IE for sensing measurement parameters, and
the first field of the IE in the request frame is a reserved field.
